(19) United States
(12) Patent Application Publication
(10) Pub. No.: US 2006/0231788 A1
(43) Pub. Date: Oct. 19, 2006

(54) Touch control water supply apparatus

(75) Inventor: Kuei-Lin Cheng, Lujhu Township (TW)

Correspondence Address: TROXELL LAW OFFICE PLLC, SUITE 1404, 5205 LEESBURG PIKE, FALLS CHURCH, VA, 22041, US

(73) Assignee: BUSINESS ZONE LTD.

(21) Appl. No.: 11/402,023

(22) Filed: Apr. 12, 2006

(30) Foreign Application Priority Data
Apr. 18, 2005 (TW) 094206036

(51) Int. Cl. F16K 5/06

(52) U.S. Cl. 251/315.06

(57) ABSTRACT

The present invention discloses a water supply apparatus includes a control valve having a hollow pipe body and connecting a water source pipeline to a water supply faucet and having a valve hole, wherein the valve hole includes a valve ball driven by a link rod for opening or closing the valve hole, and an end of the link rod is connected to a touch control module by a connecting rod, and another end of the connecting rod is connected to a restoring module by a passive rod. By the restoring power of the restoring module, the time for restoring the link rod to its original position can be adjusted, so as to control the time and quantity of obtaining water from water supply faucet and achieve the effect of saving water.

### BACKGROUND OF THE INVENTION

1. Field of the Invention

The present invention relates to a water supply apparatus, and more particularly to a hand-free touch control water supply apparatus capable of saving energy and water.

2. Description of the Related Art

In general, a water source supplies water to a faucet, when the faucet is used for obtaining water. By switching open or closed the faucet, users can control the conditions of water (such as the water output quantity and water output time, etc). If a user turns open the faucet, water will come out continuously from the faucet under a normal situation, and the user will be able to obtain water successfully. However, users usually do not have good habits of using water and always open the faucet for too long and waste water, or do not close the faucet tightly and thus causing loss of water and excessive waste of water resource. Further, if users have to use hands to turn the faucet to control the water flowing from the faucet and many users use the water supply apparatus in a public place and the faucet is not cleaned frequently, then dirt and germs may contaminate the faucet and the water supply.

There is another check valve type faucet that comes with a spring available in the market and users just need to use a part of their body (such as a leg or an arm) to press a switch to turn on the faucet for obtaining a fixed quantity of water and setting a fixed time for obtaining water. Since the faucets of this kind usually have a limitation on the time of obtaining water and cannot meet the user's required time for obtaining water, therefore users usually have to press the switch for several times, and thus causing inconvenience to users and wasting more water.

### Summary of the Invention

In view of the shortcomings of the prior art, the inventor of the invention based on years of experience in the related industry to conduct extensive researches and experiments, and finally invented a touch control water supply apparatus in accordance with the invention.

Therefore, it is a primary objective of the present invention to provide a touch control water supply apparatus that uses a valve hole of a control valve to install a valve ball for opening or closing the valve hole, and the valve ball is driven by a link rod to rotate in the valve hole, and an end of the link rod is connected to a touch control module by a connecting rod, such that when the touch control module is activated, the connecting rod drives the link rod, so that the link rod drives the valve ball to rotate and open the valve hole, and water flows from a water source pipeline to a water supply faucet, and another end of the connecting rod corresponding to the touch control module is coupled to a restoring module by a passive rod, so that the restoring power of the restoring module such as an adjustable restoring module capable of making the starting force smaller and the restoring force larger provides an easy way for users to activate the touch control module to drive link rod, and then open the valve hole for obtaining water from the water supply faucet. A larger restoring force of the restoring module can extend the time of closing the valve hole and increase the time for obtaining water and the quantity of water. Of course the restoring module can be adjusted to control the time and quantity of obtaining water according to the district of the installed faucet and the using habit of users, so as to achieve the effect of saving water.

### BRIEF DESCRIPTION OF THE DRAWINGS

The present invention will now- be described in more detail hereinafter with reference to the accompanying drawings that show various embodiments of the invention, in which:

FIG. 1 is a schematic view of the overall structure of a water supply apparatus of the present invention;

FIG. 2 is a schematic view of the structure of a control valve of the present invention;

FIG. 3 is a schematic view of rotating a valve ball of the present invention;

FIG. 4 is a schematic view of the structure of a restoring module of a preferred embodiment of the present invention; and

FIG. 5 is a schematic view of the structure of a touch control module according to a preferred embodiment of the present invention.

### DETAILED DESCRIPTION OF THE PREFERRED EMBODIMENTS

The structure, technical measures and effects of the present invention will now be described in more detail hereinafter with reference to the accompanying drawings that show various embodiments of the invention.

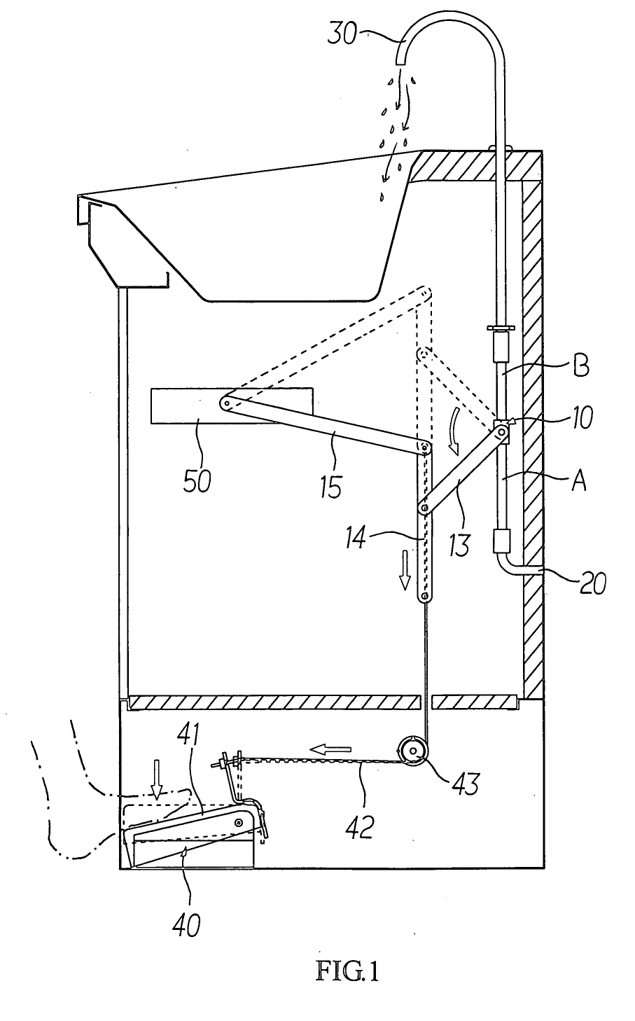

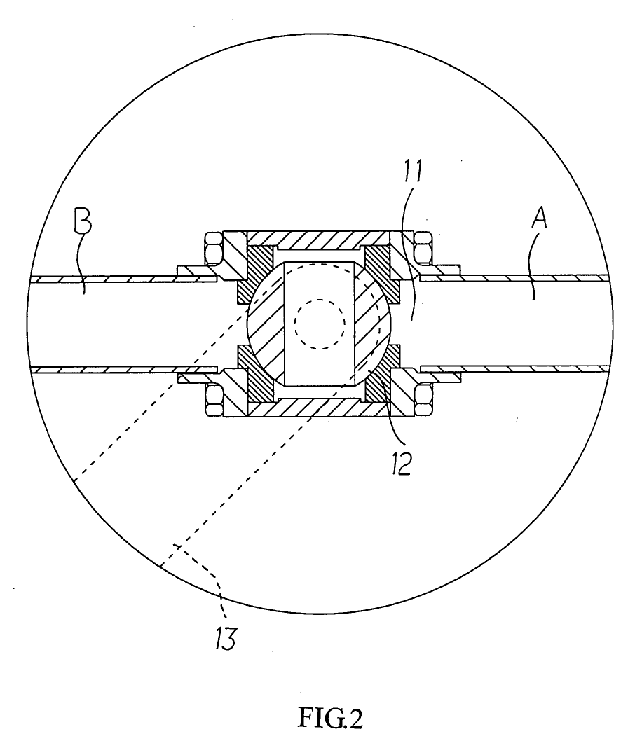

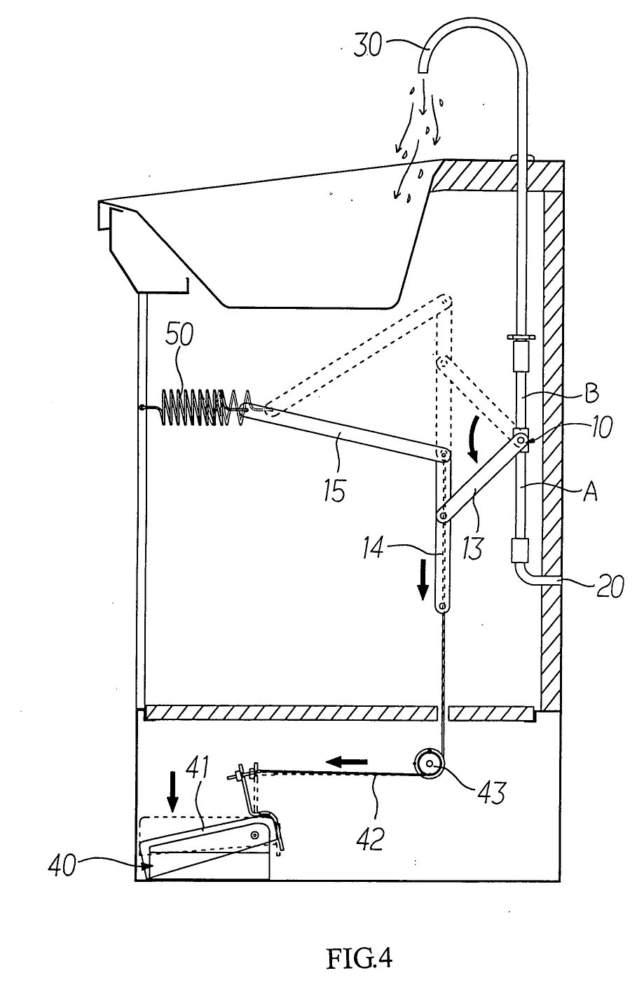

Referring to FIG. 1 for a preferred embodiment of the basic structure of a touch control water supply apparatus of the invention, the water supply apparatus includes a control valve 10, and the control valve 10 is a hollow pipe body having a water inlet A at an end and a water outlet B at another end, so that the control valve 10 can connect a water source pipeline 20 to a water supply faucet 30. Further, the control valve 10 includes a valve hole 11 as shown in FIG. 2, wherein the valve hole 11 contains a valve ball 12 for opening or closing the valve hole 11, and the valve ball 12 is driven by a link rod 13 to rotate in the valve hole 11, and an end of the link rod 13 is connected to a touch control module 40 by a connecting rod 14, and the touch control module 40 comprises an external pedal 41 and a pulling member 42 for connecting the pedal 41 and the link rod 13. In this preferred embodiment, the pulling member 42 is a steel rope, a spring or a tensile elastic steel plate sheathed onto a cam shaft 43, and the connecting rod 14 corresponding to another end without the touch control module 40 is coupled to a restoring module 50 by a passive rod 15. In this preferred embodiment, the restoring module is a hydraulic cylinder or a spring module as shown in FIG. 4.

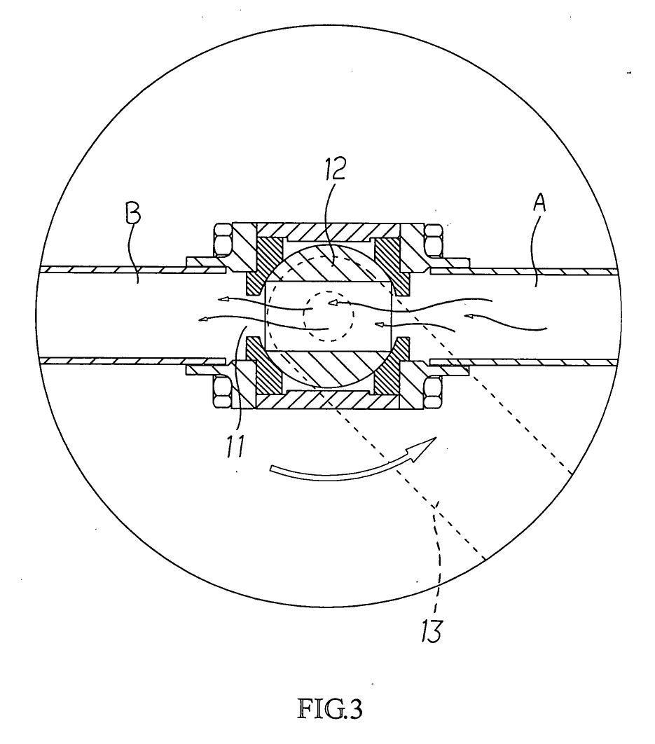

If the water supply apparatus is used (for washing hands), users need not to touch the water supply faucet 30 but simply press the pedal 41 by foot to drive the cam shaft 43 to change the moving direction of the pulling member 42 and pull the connecting rod 14, and the connecting rod 14 drives the link rod 13 and the passive rod 15 to move downward at the same time, and the link rod 13 drives the valve ball 12 to rotate 5 and further open the valve hole 11 as shown in FIG. 3. The water of the water source pipeline flows from the water inlet A to the water outlet B and a specific quantity of water flows out from the water supply faucet. The restoring power of the restoring module (such as a hydraulic cylinder or a spring module) can be adjusted, so that the starting force of the restoring module becomes smaller and the restoring force 10 becomes larger, and users can activate the touch control module without using much force. The touch control module drives the link rod to open the valve hole, and thus water flows out from the water supply faucet. The larger restoring power extends the time of closing the valve hole, and thus the time and quantity of obtaining water are increased, or the restoring module can be adjusted to reduce the time of closing the 1 5 valve hole, so that the time and quantity of obtaining water become less. Therefore, the restoring module can be adjusted to change the starting force and the restoring force of the restoring module according to the district of the installed water supply apparatus and the using habit of users, so as to control the time and quantity of obtaining water and achieve the effect of saving water.

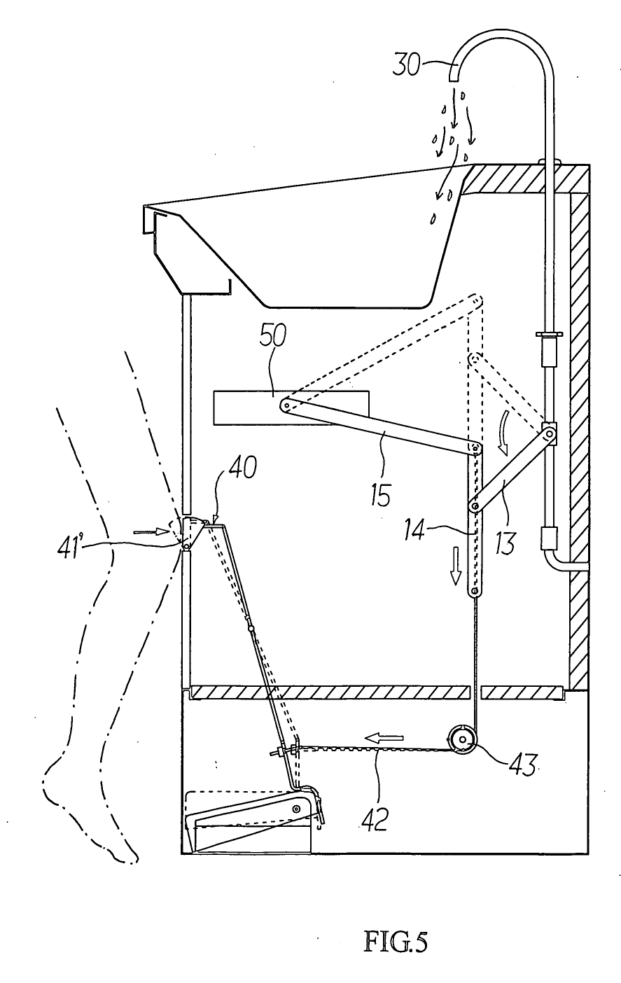

Further, the touch control module 40 comprises an external touching member 41′ and a puling member 42 for connecting the touching member 41′ and a link rod 13 as shown in FIG. 5, and the link rod 13 is connected to a connecting rod 14, and an end of the connecting rod 14 is connected to a restoring module 50 by using a passive rod 15 to achieve the water supply function and also supply water from a water supply 25 faucets for handicaps by touching the touching member 41′.

In summation of the description above, the present invention provides a better feasible touch control water supply apparatus and thus is submitted for the patent application. While the invention has been described by means of specific embodiments, modifications and variations could be made by those skilled in the art 30 without departing from the scope and spirit of the invention set forth in the claims.

What is claimed is:

1. A touch control water supply apparatus, comprising a control valve which is a hollow pipe body having a water inlet disposed at one end and a water outlet disposed at another end, such that said control valve connects a water source pipeline to a water supply faucet, and said control valve includes a valve hole, characterized in that: said valve hole installs a valve ball for opening or closing said valve hole, and said valve ball is driven by a link rod to rotate in said valve hole, and an end of said link rod is coupled to said touch control module by a connecting rod, so that when said touch control module is activated, said connecting rod drives said link rod to drive said valve ball to rotate and further open said valve hole, and water flows from said water source pipeline to said water supply faucet, and an end of said connecting rod without said touch control module is coupled to said restoring module by a passive rod, and the restoring power of said restoring module can be adjusted to change the time for restoring said connecting rod, said link rod and said touch control module to their original positions and controlling the time of water flowing out form said water supply faucet.

2. The touch control water supply apparatus of claim 1, wherein said touch control module comprises an external pedal and a pulling member that couples said pedal and said link rod.

3. The touch control water supply apparatus of claim 1, wherein said touch control module comprises an external touching member and a pulling member that couples said touching member and said link rod.

4. The touch control water supply apparatus of claims 2, wherein said pulling member is a steel rope sheathed onto a cam shaft.

5. The touch control water supply apparatus of claims 3, wherein said pulling member is a steel rope sheathed onto a cam shaft.

6. The touch control water supply apparatus of claims 2, wherein said pulling member is a spring sheathed onto a cam shaft.

7. The touch control water supply apparatus of claims 3, wherein said pulling member is a spring sheathed onto a cam shaft.

8. The touch control water supply apparatus of claims 2, wherein said pulling member is a highly tensile and elastic steel plate sheathed onto a cam shaft.

9. The touch control water supply apparatus of claims 3, wherein said pulling member is a highly tensile and elastic steel plate sheathed onto a cam shaft.

10. The touch control water supply apparatus of claim 1, wherein said restoring module is a hydraulic cylinder.

11. The touch control water supply apparatus of claim 1, wherein said restoring module is a spring module.
